(19) United States
(12) Patent Application Publication
(10) Pub. No.: US 2020/0169092 A1
(43) Pub. Date: May 28, 2020

(54) Solar Power System with Individualized Energy Prediction

(71) Applicant: HALL LABS LLC, Provo, UT (US)

(72) Inventors: David R. Hall, Provo, UT (US); Emily Brimhall, Alpine, UT (US); Jerome Miles, Spanish Fork, UT (US)

(73) Assignee: HALL LABS LLC

(21) Appl. No.: 16/199,001

(22) Filed: Nov. 23, 2018

(51) Int. Cl. H02J 3/38; H01M 10/46; H02J 7/35; H02S 40/38; H02S 20/26; E05F 15/71

(52) U.S. Cl. CPC H02J 3/383; H01M 10/465; H02J 7/35; H02S 40/38; E05Y 2900/148; E05F 15/71; H01M 2220/10; E05Y 2400/44; E05Y 2400/628; H02S 20/26

(57) ABSTRACT

A solar power system and method of data sampling to predict how much energy a solar power system will generate is disclosed. The solar power system consists of a solar panel, a battery, a sensor adapted to monitor the amount of energy, e.g. by sensing the current and voltage, generated by the solar panel, a controller which regulates the charge of the battery, and a processor which is adapted to monitor the charge of the battery. The processor receives signals from the sensor and stores the information in non-transitory memory. This solar power system may be used to operate various home automation devices, including but not limited to automated window coverings or windows. The processor preferably communicates with a user interface, which will enable the user to program the operation of the automated windows, and also view how much battery charge will be left for the remainder of the day and night.

### TECHNICAL FIELD

This invention relates to solar-powered energy and how its usage can be optimized.

### BACKGROUND

Solar power has become a popular source of sustainable energy. When a solar panel provides a charge to a battery, energy is produced at no incremental cost. It is also convenient in certain home settings, when this self-recharging solar battery can serve as a power source to an automated device and no new wiring is required to provide energy. A limitation of solar power, though, is that a solar panel and its accompanying battery can only produce and hold so much energy, and this amount varies significantly based on how much sunlight the solar panel is exposed to in a given day. The variation is caused by things such as the season, weather conditions, placement of the solar panel in relation to objects around it, as well as the orientation of the solar panel.

One solution to the problem of predicting how much energy, e.g. measured in watt hours, will be generated by a solar panel that is currently in practice is relying on available weather data. Some systems use their own satellites to monitor weather conditions, while others use third party information from an online source to predict how the weather conditions will affect how much sunlight will get to the solar panels to generate energy. Additionally, since the amount of sunlight filtering through the atmosphere to a fixed location on the Earth due to seasonal variation is known, this information is also tied in with the live weather data to make an accurate prediction for a solar panel that has maximum sunlight exposure. This method is used now mainly in commercial solar farms.

Automated window-covering systems are a natural fit for a home use of solar power. They are exposed to sunlight, and unless a home was built with the wiring for automated windows, the use of a solar panel and battery can be more convenient to the user than supplying all the windows in the house with wiring or using a battery that needs to be regularly replaced or recharged. Automated window-covering systems that use a solar panel and battery for energy are already commercially available, such as the system sold by MySmartBlinds with the available solar-powered option (see also US Patent Publication Number US 2018/0030781).

### SUMMARY

One aspect of the invention is a solar power system adapted to predict the amount of energy available from the solar power system on a particular day, or any other designated window of time. The solar power system includes a solar panel adapted to generate energy, a sensor adapted to generate signals indicating amount of current and voltage generated by the solar panel, a battery adapted to be charged by the solar panel, and a controller adapted to regulate the charging of the battery. A feature of this solar power system is a processor that is adapted to monitor the charge of the battery and to predict the amount of energy that will be available from the battery. The processor receives signals from the sensor which is adapted to sense the amount of energy over predetermined periods of time on separate days in different seasons, to thereby generate individualized sample data on the amount of energy generated by the solar panel system in different seasons. The processor includes non-transitory memory for storing this sample data and uses the stored sample data to predict how much energy will be generated. This solar power system may be used to generate energy to operate a number of automated devices, including but not limited to: window covering systems, automated windows, security cameras, motion sensors, and pool filtration devices.

A second aspect of the invention is a solar-powered automated window system. The automated window system may be a sliding window, a hinged window, or any window covering, each with an automated component with an actuator and a controller that controls that actuator. The solar powered automated window system includes a solar panel, adapted to generate energy for the one or more automated window components, a battery that is charged by the energy generated by the solar panel, and a second controller to regulate charging of the battery. Additionally, the system includes a sensor adapted to generate signals indicating the amount of energy generated by the solar panel, as well as a processor to monitor the charge of the battery and to predict the amount of energy that will be available from the battery. As in the first aspect of the invention, the processor receives signals from the sensor over predetermined periods of time on separate days in different seasons, in order to generate individual sample data on the amount of energy generated by the solar panel in different seasons. The processor utilizes non-transitory memory for storing the sample data and uses the stored sample data to predict the amount of energy available from the battery on a particular day or any other designated period of time. The automated window system also features a user interface, which receives information about the predicted amount of energy available for one or more automated window components.

A third aspect of the invention is that the solar-powered home automation devices may be fitted with sensors designed to alert the user to certain conditions, and in some cases automate the device in response to a stimulus without user interaction. Examples include a sensor sensing the presence of carbon monoxide and sending a signal to an actuator to open a sliding window automatically, or a sensor receiving an alert from a connected smoke detector and sending a signal to an actuator to open a hinged window.

### BRIEF DESCRIPTION OF THE DRAWINGS

The following drawings are provided to illustrate certain embodiments described herein. The drawings are merely illustrative, are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is an illustration depicting two windows in the same house receiving different amounts of sunlight.

FIG. 2 is a three-dimensional drawing of a home, featuring various automated devices including a pool filtration device, outdoor lighting, a security camera, and a motion sensor.

FIG. 3 is a perspective view of the solar power system, with a cutaway showing the processor, battery and related elements;

FIG. 4 is an isometric view of a motorized window with solar panels, an outer view of the two motors and gearboxes, and a zoomed-in inset of said solar panels;

FIG. 5 is an isometric top-left view of a motorized sliding segment in a frame, as well as an attached sensor and unattached receiver;

FIG. 6 is a perspective view of the mechanism of the gears that lower and raise an automated window covering, as well as a receiver and an actuator;

FIG. 7 shows an automated window covering and a user interface, with a cross-sectional view of the automated components;

FIG. 8 is an illustration showing an embodiment of three motorized windows, a first hub, and a user interface wirelessly connected in accordance with the invention;

FIG. 9a shows a graphical user interface for adjusting settings on a motorized window or window covering;

FIG. 9b shows a graphical user interface for displaying a programmed schedule associated with a motorized window or window covering;

FIG. 9c shows a graphical user interface displaying an alert regarding lack of estimated battery charge for remaining programmed schedule associated with a motorized window or window covering;

FIG. 9d shows a graphical user interface for monitoring an estimated battery charge level remaining for each automated window or window covering in a room.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “solar panel” is meant to refer to a panel that absorbs the sun's rays as a source of energy for generating electricity. Each solar panel is typically comprised of an array of photovoltaic cells, mechanically and electrically connected to provide electrical energy as a unit.

As used herein, “processor” is an electronic device for storing and processing data, according to instructions given to in a variable program.

As used herein, “non-transitory memory” is meant to refer to computer-readable media that stores data for short periods or in the presence of power such as a memory device or Random Access Memory, known in computer science terms as RAM.

As used herein, “user interface” is meant to refer to a device dedicated to the purpose of operating home automated devices, or a smart device utilizing an app that is adapted to operate home automated devices.

As used herein, “smart device” is meant to refer to such items as a tablet, smart phone, or tv-connected device that is adapted to run apps. In the figures, a smart phone is depicted, but a smart device may include the prior listed items and others.

As used herein, “online weather data” is meant to refer to real time weather data and weather forecast data that is provided by one or more available weather forecasting services via the Internet.

As used herein, “cloud-based network” is meant to refer to any kind of network that connects smart devices, computers, wireless routers, modems, and/or otherwise connected home automation devices and their controllers to each other and, in some instances, the Internet.

As used herein, “home automation device” is meant to refer to an object in the home that requires electric power to automate, and that may be connected to a cloud-based network and be controlled via a controller, user interface, smart device, or similar.

As used herein, “automated window system” is meant to refer to a system of windows that are automated to open and close. They function like any home automation device defined above.

As used herein, “actuator” is meant to describe the moving mechanism of the home automation device; it is the part of the invention that functions upon receiving a signal to move and requires a source of energy to do so.

As used herein, the term “energy” is meant to refer to electrical energy and can be measured with various units, such as watt hours or Joules. The typical units for measurement of energy generated by a solar power system is watt hours.

As used herein, the term “season” and “seasons” are intended to have relatively broad meaning, referring to different times of year, and not necessarily limited to the four traditional seasons of spring, summer, autumn, and winter.

In some instances, features represented by numerical values, such as dimensions, quantities, and other properties that can be represented numerically, are stated as approximations. Unless otherwise stated, an approximate value means “correct to within 50% of the stated value.” Thus, a length of approximately 1 inch should be read “1 inch+/−0.5 inch.” Similarly, other values not presented as approximations have tolerances around the stated values understood by those skilled in the art. For example, a range of 1-10 should be read “1 to 10 with standard tolerances below 1 and above 10 known and/or understood in the art.”

Commonly owned U.S. Patent Publication US 2017/0107758, entitled CONSOLIDATED GEARBOX CONTROLLER IN A WINDOW COVERING WITH EXTERNAL SENSOR INPUT discloses, among other things, an automated window cover system that is powered by a solar power system, comprising a relatively small solar panel that is attached to the headrail of the window covering, i.e. blinds. The system is controllable from a remote device, such as a smart phone running an app and is also programmable. For example, the blinds can be programmed to open in the morning, close in the bright afternoon, opening in the evening and close again at night. The program can be more sophisticated, with partial openings and partial closings to provide different levels of sunlight and/or privacy at different times of day.

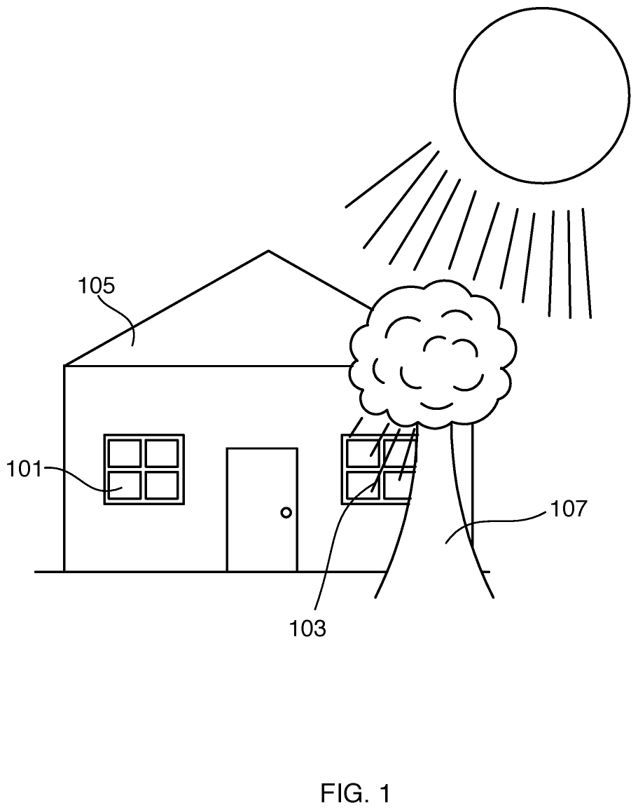

FIG. 1 is an illustration of two individual windows, 101 and 103, on the same house, 105, receiving different amounts of sunlight. While the sun shines fully on window 101, window 103 is partially shaded by the tree 107. Both windows 101 and 103 are outfitted with solar power systems to automate their windows and window coverings. The solar power systems each include a solar panel that produces energy and charges a battery. On a typical day, because of the tree 107 partially shading window 103, the solar panel on window 101 will be expected to produce more energy than the solar panel on window 103. As such, the battery on window 101 will receive a higher charge on a typical day than the battery on window 103. This means that the battery on window 101 is able to provide more power each day for the movement of the window 101 and/or window coverings than the battery on window 103. Depending on the size of the battery and the power needed for each operation, this can put limitations on the number of times the windows and/or window coverings can be moved on window 103 on a given day. For example, the difference between the energy generated by the solar panel on window 101 and that generated by the solar panel the window 103, could mean that the window 101 can be opened and closed 8 times in a day, while the window 103 can be opened and closed only 4 times in a day.

In order to determine the watt hour estimate for a solar power system, preferably three factors are involved. One is online weather data, as it is made available via a cloud-based network. Weather predictions for sunshine or thick cloud cover and weather conditions in between will affect how much energy a solar panel can absorb, and consequently will affect how much energy the processor will predict the solar panel system will generate that day.

The second factor that may be used by the processor to predict the energy to be generated that day is the day of the year and geographic location of the solar panel system. The amount of sunlight that reaches a point on the Earth on a given day at an exact location is a known constant and may be computed by the processor and factored into its predictive algorithm.

The third factor that the processor will rely on to predict the energy to be generated is a data sampling of how much energy that individual solar power system has generated in the past. This data will be stored in non-transitory memory. The processor receives signals from the solar power system's sensor over predetermined periods of time on separate days in different seasons, to thereby generate individualized sample data on the amount of energy generated by that particular solar panel in different seasons.

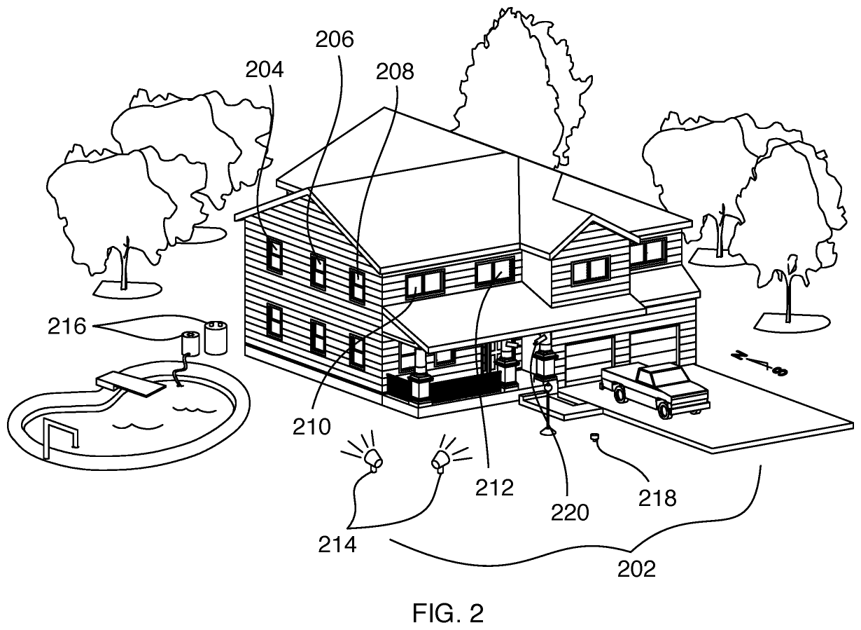

FIG. 1 illustrates the difference between two windows on the same side of a building. FIG. 2, which depicts a house 202, shows the reality that many windows 204 206 208 210 and 212, and accompanying solar power systems, on the same house will receive vastly different amounts of sunlight on the same day. In one example, one solar power system might receive full sun in the summer months but might be shaded in other seasons, i.e. have a “southern exposure.” On house 202, windows 210 and 212 receive direct sunlight in the summer due to their southern exposure, while windows 204, 206 and 208 receive more sunlight in other seasons. As such, the solar power systems on windows 210 and 212 will produce more energy in the summer than the other seasons. This is why each solar power system described by the invention includes a processor that monitors the charge of the battery and stores this data in non-transitory memory and transmits that data in sample sets, usable by an algorithm to determine the individualized amount of energy each solar power system generates on a given day. This sample set is unique for a solar panel's location, whether it is shaded by a tree, or what cardinal direction it is facing, as well as the season that the data was taken. The algorithm is able to take season into account, to provide an increasingly accurate estimate of how much energy each solar panel can be expected to generate on any specific day of the year.

In solar power systems that provide energy for small appliances, such as window coverings or window openers; the size of the solar panel will be kept as small as possible, for aesthetic reasons and to keep costs down. Naturally, the amount of energy produced by smaller solar panels will be limited and the batteries charged thereby will have a limited charge to operate the appliance between daily recharging from the solar panel. Consequently, it is important to manage the use of that limited charge to enhance the user's experience. For example, it would be helpful to give the user some indication of how much charge he can expect from that battery on any given day. Also, if the appliance is the type that can be programmed for multiple actions in a day, it would be helpful to let the user know if the charge needed for the number or type of actions being programmed was going to exceed the charge available from the battery on that given day. In a simpler system, the appliance could be configured to not allow the user to utilize a program that will require more energy than the solar panel will be capable of generating that day. Also, because one aspect of this invention can control the openings and closings of windows, it is helpful if the automatic programming saves enough energy to last through the night time, as well as enough for one use, e.g. to open the window, in the case of an emergency.

If the user relied on a sensor that only showed how much charge the battery presently has, he or she would not see an accurate depiction of how much charge the battery is going to have throughout the day and into the night, and therefore the user is not able to take into account how many times the battery can be relied upon to power the home automation device, be it a window covering, window, pool electronics, etc., when programming the device.

FIG. 2 depicts various uses of this technology. The solar power system with a predictive algorithm can be used to provide energy for a security lighting system 214, a pool filtration system 216, motion sensors 218, and a camera 220, among other things. It is not limited to window coverings or automated windows, nor is it limited to home automated devices.

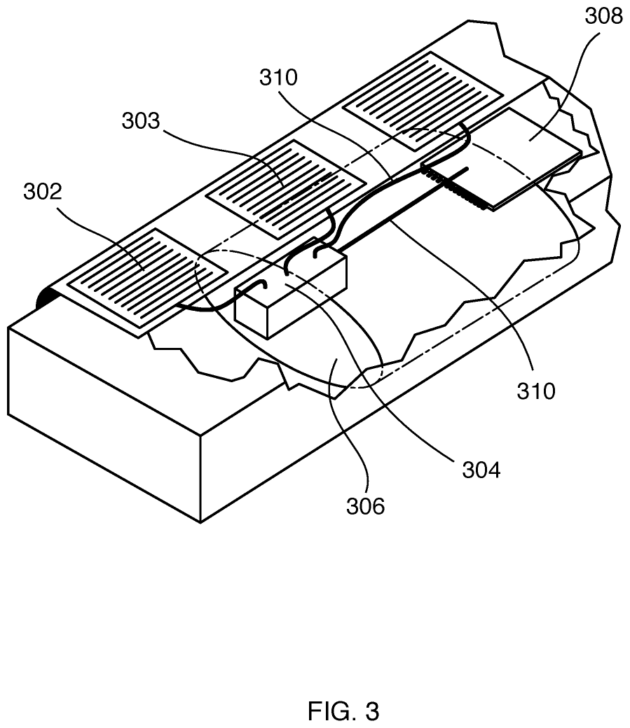

FIG. 3 depicts a solar power system. 302 is a solar panel, typically made up of multiple photovoltaic cells (PVC's) 303, which absorbs energy from the sun and is engineered to generate energy. Wire 311 connects the solar panel to the controller 304. 304 is a controller, which is necessary to regulate the energy generated by the solar panel and channel it into the rechargeable battery, 306, where the energy can be stored until it is needed. 308 is a processor, which monitors the charge of the rechargeable battery 306. 308 possesses non-transitory memory to store the sample data for how much energy the solar power system is generating each day. Processor 308 receives this data from sensor 310, which is adapted to sense the amount of current and voltage generated by the solar panels. The current and voltage together are used to determine the total amount of energy generated by the solar power system. The processor 308 is able to send and receive data over a cloud-based network, either to a network hub or a designated user interface, depending on how the automated device or system is set up. All of these components make up what is referred to as a “solar power system” throughout the application. This is one representation of a solar power system, and the invention is not limited by this visual representation of one.

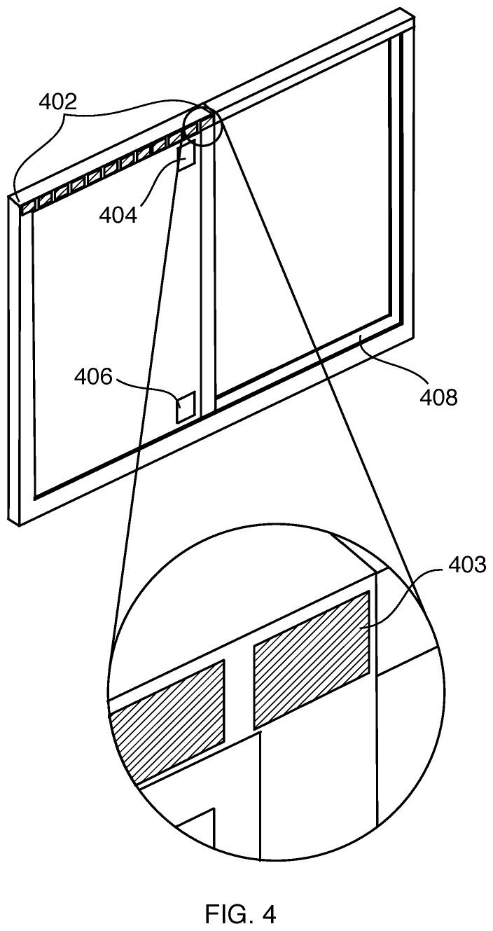

FIG. 4 depicts an automated sliding window, outfitted with a solar power system. As depicted by the inset, the system includes photovoltaic cells, 403, which together make up the solar panel 402, placed along the window pane facing outward. 404 and 406 show an outward view of a fixed motor assembly, which in this embodiment comprises the gears, motor and gearbox. The motor assemblies 404 and 406 move the window along track 408, to open and close it, which are in turn powered by the stored energy from the battery of the solar power system, or “charge” of the battery. When units of energy, or watt hours, are stored in a battery, they are referred to as the charge of the battery. It is to be understood that a “charged battery” is one filled to its energy capacity, and the charge of a battery generally refers to the amount of energy, or watt hours, it has in reserve. This automated sliding window, that moves along a geared track and is powered by the solar power system, is the preferred embodiment. From this outward view, only the solar panels 402 are seen, but all components of the solar power system are included.

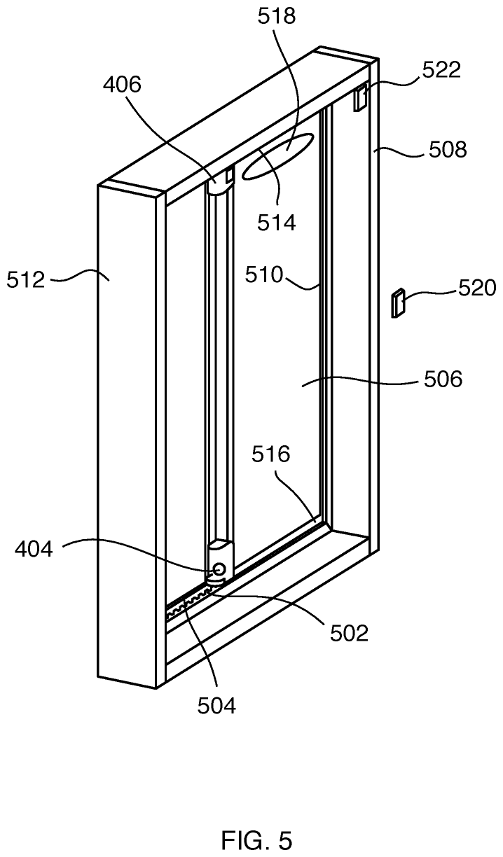

FIG. 5 is another depiction of the automated sliding window outfitted with a solar power system. FIG. 5 is provided to view the interior of the window, notably the geared track 504 and motorized mechanisms of the automated sliding window. FIG. 5 shows an isometric top-left view of a motorized sliding segment 506 in a frame 508 with a gear track 504 mounted to a slidable segment 506. It is intended to depict the same embodiment of the invention depicted in FIG. 4. In this embodiment, the fixed motor assembly 406 is mounted to the fixed window frame, and gear 502 engages with gear track 504. Although two fixed motor assemblies, 404 and 406, are shown, any number of fixed motor assemblies may be used. Unseen are the gears and geared track along the top of the window depicted, which is blocked by the top-left view. In instances where the sliding segment slides up and down, motor assemblies may be mounted on either vertical member 510 or vertical member 512. While FIG. 5 shows the geared track 504 on the bottom of the frame, it is appreciated that a motor assembly may be affixed to any location on the frame without departing from the scope of the present systems, devices, and methods. Unseen on FIG. 5 are the solar panels which could be seen on this embodiment of the invention on FIG. 4. The invention of the solar power system provides the energy required to automate the window.

Motor assemblies 406 may contain a motor, and one or more: gears; gearbox; transmission; worm drive; processor, or combinations thereof. Gear tracks 504 may be affixed to the top and bottom horizontal members 514 and 516, as they are depicted in this embodiment. The gears 502 mesh with the teeth of the gear tracks 504. The motors 404 and 406 turn the gears in a first direction, causing the gears 502 to walk along the gear tracks 504, causing the slidable segment 506 to slide towards this vertical member. Rotation in the opposite direction walks the gears the other direction, pulling the slidable segment the other direction.

Additionally, located alongside the motor within the fixed motor assembly 406 is a processor. The processor may receive user data from one or more user input devices, or “user interfaces” as defined within this application. The processor may include one or more communication systems, including Bluetooth communication chips, Internet Wi-Fi transceivers, network transceivers, a wireless mesh network device such as Z-Wave network transceiver, or a combination thereof. The one or more communication systems may communicate with at least one of an external controller and a cloud-based network. The one or more communication systems may receive instructions from the controller, generate signals instructing a second motor 404 on the opposite track to rotate in a direction, receive signals from the second motor 404 regarding a status of the second motor, and generate a signal informing the user interface of the status of the second motor 404.

Also included on FIG. 5 are two sensors. A carbon monoxide sensor 518 and a temperature sensor 520 are optional features included in this embodiment of a solar-powered automated window. In some embodiments, the processor located within 406 or 404 may communicate with these sensors. In this embodiment, there is a dedicated processor, 522, for receiving and transmitting information from the sensors. Processor 522 is able to send signals to the motor assemblies to operate the window, and alerts to the user interface, in certain instances.

Regarding other configurations and options for configuring a solar-powered automated window, the motor assembly may include a transmission that drives the one or more gears, wherein the transmission locks the slidable segment to at least one gear track when the transmission is not driven by the motor.

The slidable segment may be slidably mounted by being between tracks on the first horizontal member of the frame and a second horizontal member of the frame, the tracks allowing the slidable frame to freely move side to side.

The frame may also have a latching device that mates to a latching receiver attached to the slidable segment, wherein mating prevents movement of the slidable segment. The latching receiver may also include a communication device that generates a signal when the latching device is mated and transmits that signal to the controller, which generates a control signal that deactivates the motor. The latching device may also have a release mechanism configured to automatically release the first gear from the first gear track, thereby allowing the slidable frame to be moved to an open position by the user, in response to an emergency condition as detected by at least one of the one or more sensors.

It will be noted that while the drawings depict a window that opens and closes in a horizontal orientation, the motor is capable of functioning with a window that slides in a vertical orientation. In the vertical orientation the motor or motors will be affixed to the side vertical members instead of the upper and lower horizontal members. The gear track will also be attached to the side vertical members. In the vertical orientation coordinating the motors becomes especially important so the sliding segment will raise and lower. When the motor or motors are not coordinated there is a greater chance of the sliding segment tilting or canting and binding up so the sliding segment will stick and no longer move. The motor connected to a vertically oriented sliding window will retain all the characteristics of the motor connected to a horizontally sliding window.

In some embodiments of automated windows, the battery from the solar power system will be used to provide energy to an actuator that automates a window in ways beyond opening and closing it along a geared track. The actuator may include one or more of electric motors, gearboxes and one or more mechanical means of incrementally opening, closing, tilting, turning, twisting, sliding, pushing, pulling, or rotating one or more components of the actuated device.

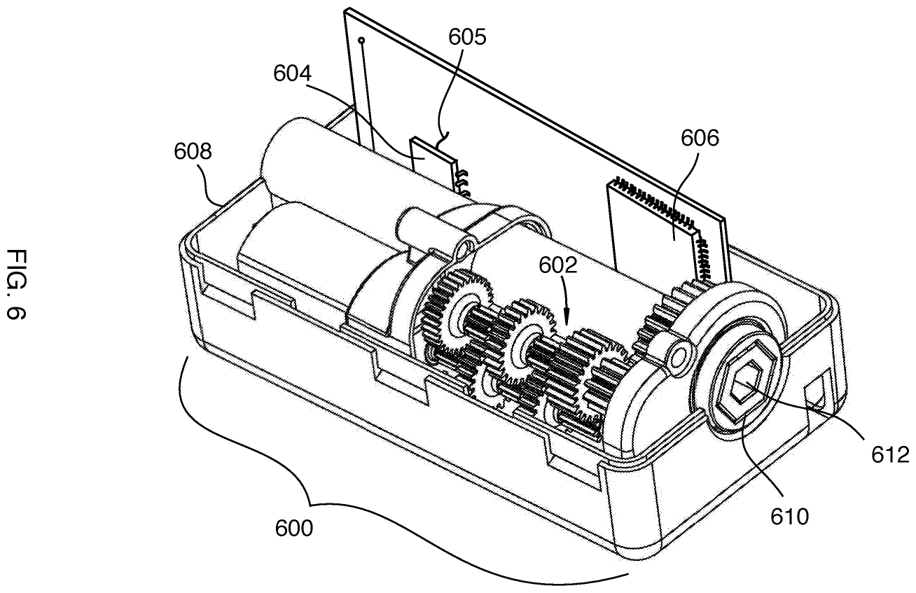

FIG. 6 depicts one embodiment of a suitable motor and gearbox for use in a solar-powered automated window covering. As shown, the motorized gearbox assembly 600 has a substantially rectangular footprint to enable it to fit within a headrail of a window blind. Motor and gearbox 600 include gears 602, controller 604, and transceiver 605. As shown, the motorized gearbox assembly 600 also includes a printed circuit board (PCB) 606. Electronics (e.g., processor, non-transitory memory, communication modules, etc.) to control the motor 608 and/or gather data associated with the motorized gearbox assembly 600 may reside on the circuit board 606. The circuit board 606 contains the processor which enables various features which will be discussed at length later regarding the programming features of the automated window covering system. It is not essential, however, that the processor resides in the gearbox, and it is only depicted as such in this particular embodiment. The gearbox depicted in FIG. 6 is suited to actuate an automated window covering, specifically blinds. In combination with the components of the solar power system, the depicted gearbox can tilt, raise, or lower a winder covering.

Controller 604 and transceiver 605 may be any of a variety of off-the-shelf and/or custom manufactured devices. For example, in some embodiments, transceiver 605 is one or more of a WiFi transceiver, Bluetooth transceiver, Zigbee transceiver, or Z-wave transceiver. In some embodiments, transceiver 605 is a SureFi transceiver. SureFi is a long-range, low data wireless spread spectrum frequency hopping protocol on the 902-928 MHz ISM band.

As shown, motor 608 drives gears 602 coupled to output shaft 610. Output shaft 610 drives a tilt rod, not shown. In the depicted embodiment, output shaft 610 extends the length of motor 608 and gearbox 602. Output shaft 610 includes a through-channel 612, extending the length of the output shaft 610, to enable the tilt rod to pass therethrough. In some embodiments, the output shaft rides on bearing surfaces at each end of the motor and gearbox.

All of the above components depicted in FIG. 6 are one embodiment of a mechanism that may be automated by the solar power system, in this case, window covering systems. FIG. 6 is a depiction of a motor and gearbox designed to automate window blinds, and it is included to illustrate one way the home automated devices communicate and connect with the cloud-based network.

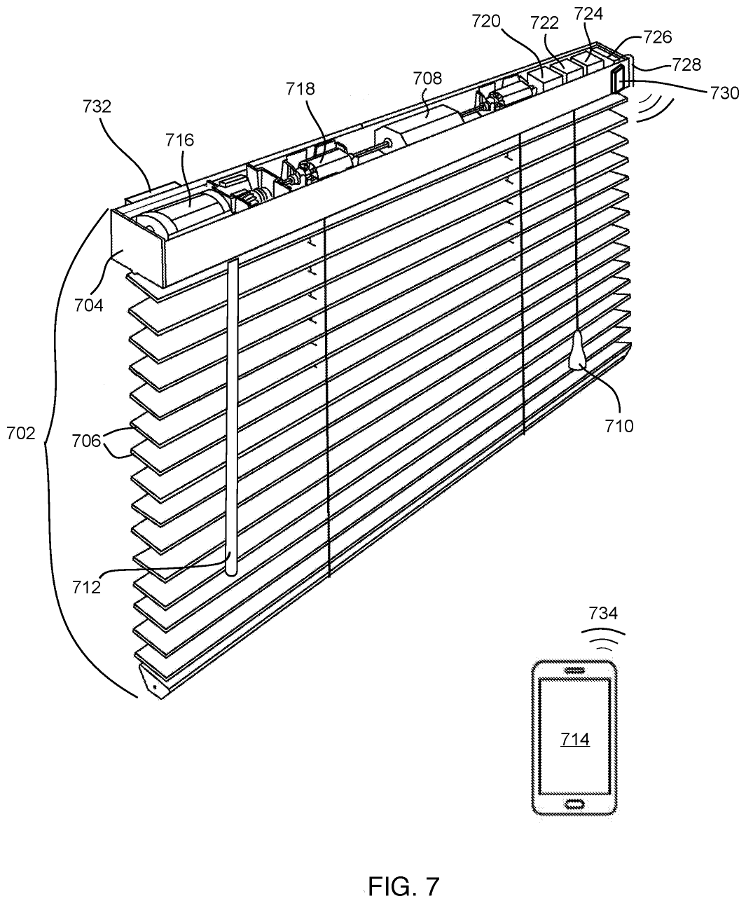

Referring to FIG. 7, an automated window covering is depicted. In this example the automated window covering is motorized window blinds 702. As shown, the window blinds 702 include a main enclosure in the form of a headrail 704, containing various components, and slats 706. In the illustrated embodiment, the window blinds 702 include a motorized gearbox assembly 708 configured to automatically tilt the slats 706 of the window blinds 702. Examples of user input devices are shown as a pull cord 710, tilt wand 712, and user interface 714.

FIG. 7 further illustrates system components located within the headrail 704 as follows: An enclosure 716 for a rechargeable battery, current and voltage sensor, regulator and processor for the solar power system; actuator 718 which includes motors for raising and lowering the blinds, motors to tilt the blinds, and motors that drive the gearbox assembly 708; controller 720; processor 722; network device 724; and wireless transmitter and receiver 726. Located adjacent to the headrail 704 is an antenna 728, temperature sensor 730, and solar panel 732.

The user interface, as shown in FIG. 7, transmits and receives wireless signal 734 from the wireless transmitter and receiver 726, allowing wireless control by a user of the system. Bluetooth communication is preferred, which is present in most mobile devices such as cell phones, laptops, or tablets.

An essential aspect of the invention is the tailored information it provides to users who rely on solar power to run their home automation devices. As such, many of the benefits and usefulness of the invention are realized when the mechanical features are connected with the programmable user interface, as well as an option for integration with safety sensor and real-time weather data.

Two embodiments of a user interface described below are for the operation and programming of a system of automated windows, and automated window coverings. However, a user interface may also be used to operate and program other devices that are powered by the solar power system in the invention, such as security lights, front door cameras, pool filters, and others.

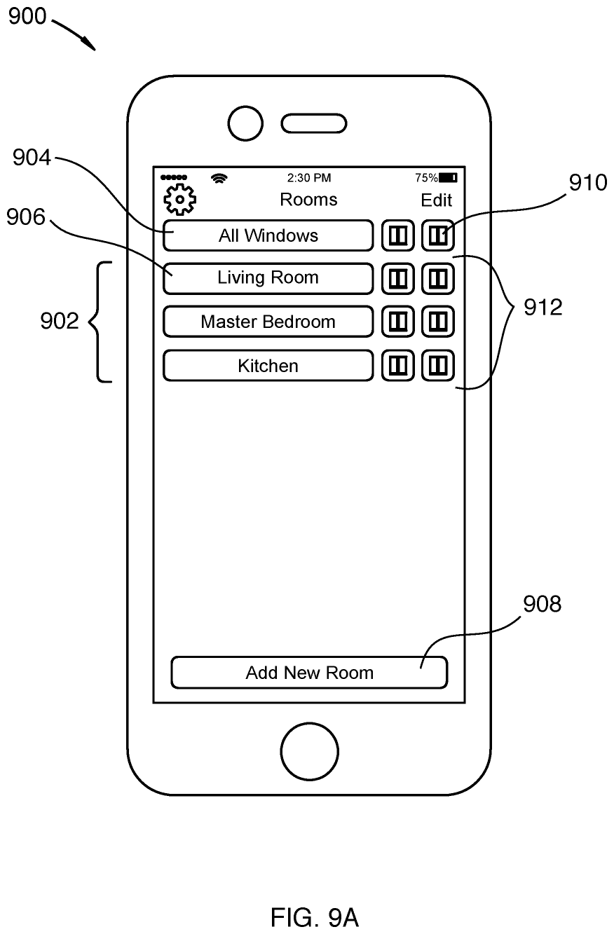

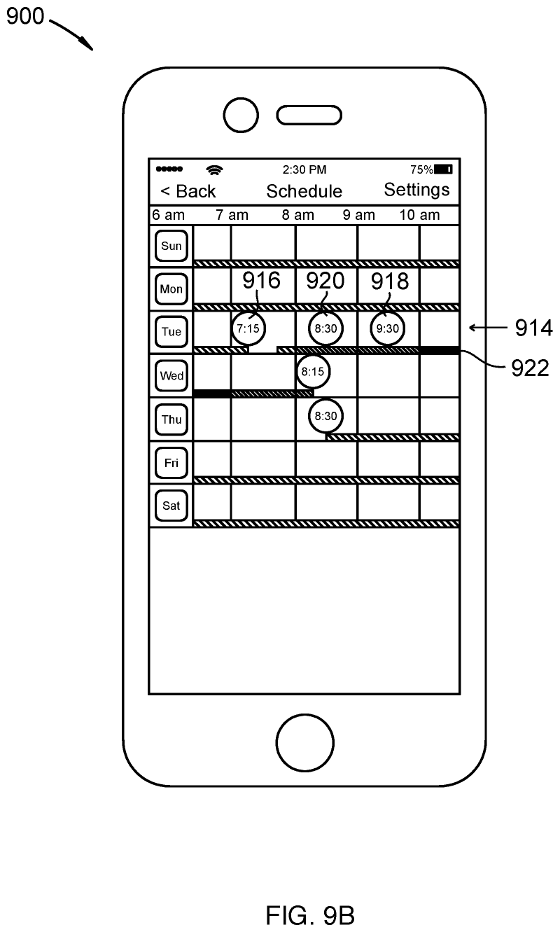

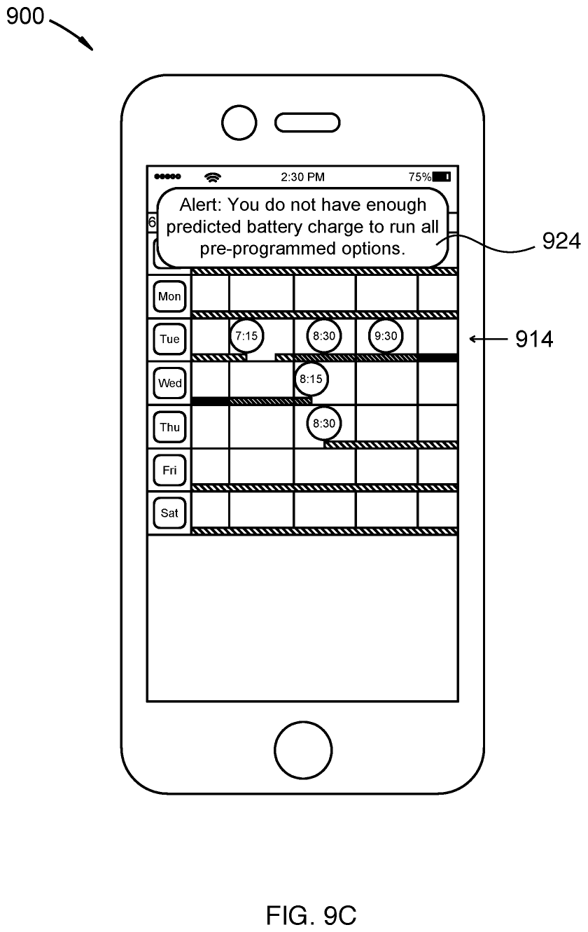

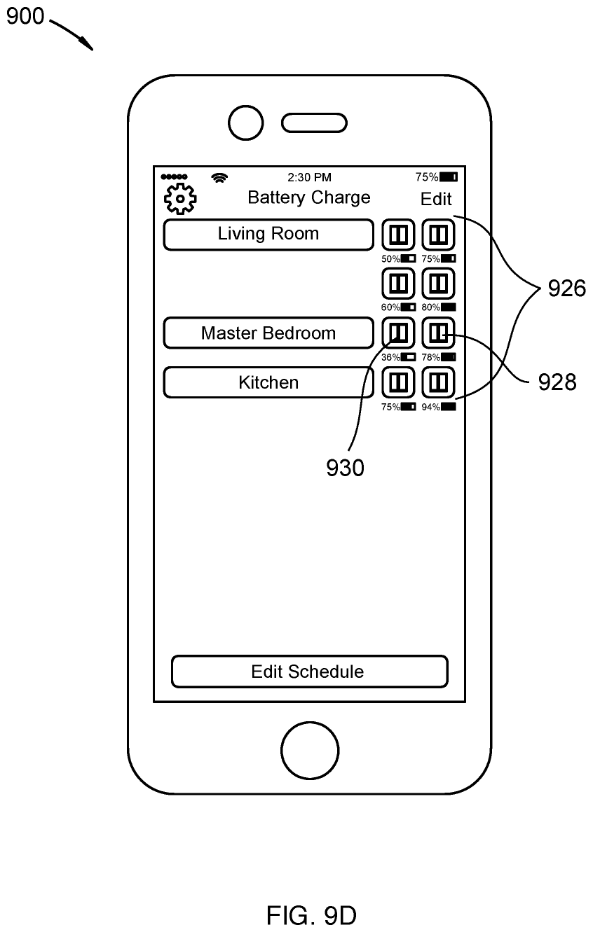

The user interface is an important feature of the preferred embodiment. In certain preferred embodiments, the user interface is configured to run as an app on a user's mobile device, such as a tablet or smart phone. FIGS. 9a, 9b, 9c and 9d, show various exemplary graphical user interface (GUI) pages associated with an application configured to execute on a mobile device. Nevertheless, in other embodiments, the application may be configured to execute on a desktop computer, workstation, laptop, or other suitable computing device. The user interface may also be manufactured and sold as an electronic device whose sole function is to program, control and otherwise operate the automated devices being powered by the invention. The user interface is equipped with various programming features, from smart habit-learning abilities to weekly scheduling. The user interface is also able to alert a user when the remaining programmed operations for a device exceed the expected battery charge available. And, if the user chooses to incorporate sensors or different security devices in their home and cloud-based network, the user interface can work as a hub and alert system for when action should be taken.

Within the user interface, there may be a learning module programmed to analyze patterns of the user, drawing from available data, including but not limited to user behavior, weekly or daily patterns, and room by room variation. As depicted in FIG. 6, the motor and gearbox 602 contains a transceiver 605 attached to the controller 604 to receive wireless instructions to control the actuator and thus, operation of the automated window covering. In addition, the circuit board 606 includes a processor capable of storing and transmitting data. In this way, not only can the user interface transmit operational instructions to automated windows and window coverings, but the processors located within the motors can store and send back data about user habits.

Similarly, motor assembly 406 contains a processor which not only receives data but communicates data to the processor on motor assembly 404, and to the user interface. Example data that motor assembly 406 could transmit is the functioning of motor assembly 404 or 406, synchronization of motor assemblies 404 and 406, and user behavior regarding any patterns in the operation of the automated window.

The programming may provide additional information regarding how the user uses the windows or window covering in a certain room. For example, if a user sets up a window covering in a west facing room, the processor in the system may direct the function of that window covering to close every Summer afternoon to reduce heat loading. However, if the learning module determines that a specific user always opens the blinds on a Summer afternoon when they enter the room, the program can “learn” to automatically open the window coverings to let the sun in whenever that user enters the room. The user always has priority over the stored settings for a present time of use. The system may be set up to implement permanent user settings after X number of overrides by a specific user. Not only will the user always have the option to turn on or off this ‘learned’ automation, but, in accordance with the energy monitoring nature of the invention, the programming will automatically block any self-automated openings or closures when the predicted energy remaining for the day is approaching a level insufficient to run the user-programmed options, and operate appropriately in response to connected sensors or in case of emergency.

An additional programming feature takes into account the placement of windows throughout the home, which streamlines the process for the user. Different window coverings or automated windows may be located in more than one room in a building having different orientation or facings. As seen in FIG. 2, windows 204, 206 and 208 are all west facing. Users may benefit from applying different settings to west facing windows than east or north facing windows. These settings may be modified at the time of setup. Once the window facings and orientations are known, the processor may be programmed to modify the factory presets for this specific window covering based on its location and facing. For example, east facing window coverings in bedrooms may not go up until 8 AM, or whatever time the user inputs as their daily wake-up time. This programming option is available for user convenience, to provide a starting template.

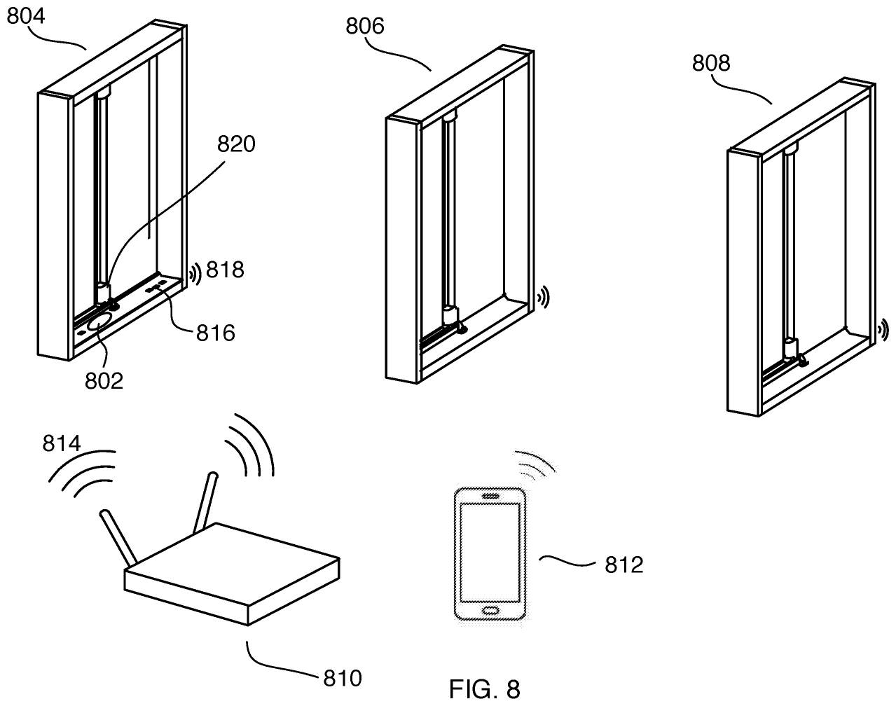

Referring to FIG. 8, an example of three motorized windows, 804, 806 and 808, a cloud networking device 810, a carbon monoxide sensor 802, and a user interface 812 are illustrated. Although a carbon monoxide sensor is used in this illustration, other safety sensors such as smoke detectors or a timer-activated motion sensor, may be used in a similar system. In this example embodiment, the three windows illustrated are connected via Bluetooth mesh wireless signal 814. Processor 816 functions analogously to processor 518 from FIG. 5. In this system, Processor 816 is adapted to receive and transmit data, as illustrated by wireless signal 818. Processor 816 is able to receive data from the carbon monoxide sensor 802, and it uses its information processing technology to determine when the data from the carbon monoxide sensor elicits a response, and then triggers an appropriate reaction. For example, if the carbon monoxide sensor 802 detects 35 parts per million of carbon monoxide in the air or more, the processor 816 recognizes that the carbon monoxide detected by sensor 802 has reached unsafe levels. In turn, processor 816 will send a signal directly to the motor assembly 820 to open window 804. Additionally, processor 816 will transmit a signal to all of the motorized windows connected via the cloud-based network with instructions to open, which in this network would be windows 806 and 808. Additionally, the processor 816 will send an alert to the user interface 812 that carbon monoxide has reached an unsafe level in the home, informing the user that the windows have been opened. For cases like this, in which safety requires that a window be opened, the processor of the solar power system will always save enough energy for one operation. Even if the user does not have any sensors in their home automation network, a situation may arise where the user finds it necessary to open the window. Without a reliable prediction of remaining energy, such a safety measure on solar powered windows would not be possible.

In FIG. 9a, one embodiment of a page from the user interface for configuring a home is illustrated. This page may enable a user to add, delete, modify, or monitor automated window openings associated with a particular room or space. As depicted in FIG. 9a, in this embodiment the user can see what windows, if any, in the living room, master bedroom, and kitchen are open. The user can choose to manually override any pre-programmed options if they wish to open or close a window.

FIG. 9a shows one embodiment of a Rooms page that enables a user to establish “rooms” in a home, sorting individual windows into groups, as well as operate all automated windows in the home or in a room of the home as one single group. In the illustrated embodiment, buttons 902 are provided to represent each room in the home, as they have been inputted by the user. Selecting a button from 902 may enable a user to configure the home, or a room in the home, such as by adding an automated window to the home, or particular room. Alternately, selecting the “All Windows” button 904 may allow the user to configure all windows associated with the home or business. Similarly, selecting the “Living Room” button 906 may allow the user to configure windows in the user's living room. An “Add New Room” button 908 may enable a user to add a new room to the list of Rooms 902.

Referring again to FIG. 9a, in certain embodiments in accordance with the invention, an application may be provided that allows a user to efficiently control all automated windows, either at once or by room. The option to close all windows with one button would be very helpful during a sudden rainfall. Button 910, in the illustrated example, will close every automated window with one button. In one application, from the Rooms page, buttons 910 and 912 may be used to open and close windows in real time, while buttons 902 and 904 open menus for programming options for either all windows or groupings of windows.

As an example, a button from 902 may be selected to configure an automated window or a group of automated windows to operate in accordance with a defined schedule. For example, a user may want a window or a group of windows to open and/or close at designated times. In certain embodiments, different open/close times may be established for different days of the week. Selecting the button may open up a page that enables the user to configure the windows to operate in accordance with the established schedule. One embodiment of such a page is illustrated in FIG. 9b.

Referring to FIG. 9b, one embodiment of a page for establishing a schedule for a window or a group of windows is illustrated. In the illustrated embodiment, a time line is provided for each day of the week. Time line 914 is illustrates the scheduled program for one particular day. A user may establish different types of events on the time line 914. For example, a user may wish to establish an open event 916 at a designated time and a close event 918 at a different designated time. For example, as shown in the illustrated embodiment, an open event 916 is established at 7:15 AM and a close event 918 is established at 9:30 AM. In certain embodiments, events may also be established for states other than open/close states. For example, a user may want a window or a group of windows to be fifty percent (or some other percentage) open at a designed time. In the illustrated embodiment, a partial open event 920 is established at 8:30 AM.

In certain embodiments, each time line may have a status bar associated therewith. As illustrated in FIG. 9b, 922 is shows a status bar, which visually depicts if a window is open or shut. This status bar 922 may show a status of a window or a group of windows during different time periods. For example, the color white on the status bar 922 may indicate that a window or group of windows is open over the indicated time period. Similarly, the color black may indicate that the window or group of windows is closed during the indicated time period. Shades of grey may indicate a state of partial openness, the degree of which may be indicated by the shade. FIG. 9b illustrates status bars correlating with the programmed open and close schedules. As an alternative to a user selecting “half open”, the user interface may provide a “slider button”, in certain embodiments. As an example, a slider button on a touch screen could be provided to allow a user to select what level of open or closed they wish the window or group of windows to be, by simply sliding their finger sideways or up and down. The slider button could be used to open or close the windows partially or completely.

Not shown, a button may be provided to configure a window or group of windows to automatically close at sunset. A schedule may be automatically determined based on a time of year and/or location or orientation of a motorized window or automated window covering. For example, a user may schedule a motorized window to open at sunrise and close at sunset. The user interface may draw information from the cloud-based network to determine sunrise and sunset times for the motorized window based on the motorized window's location and the time of year and schedule opening and closing time accordingly. These opening and closing times may be adjusted throughout the year as the position of the sun changes.

There are other programming options that are enabled with the addition of sensors, that will be further explained in the text below. These can include opening a window when a room gets to a certain temperature that is uncomfortably hot, or using a light sensor located outside to determine when to open and close a window covering.

As is illustrated in FIG. 9c, the user interface provides a feature to alert the user within the user interface when the programmed options exceed the expected remaining energy of the solar-powered battery. As stated earlier, the user interface refers to energy as “battery charge” since battery charge is another way to describe how much stored energy a battery has. FIG. 9c illustrates the alert 924 popping up over a depiction of the weekly schedule 914, but this alert may pop up whenever the user interface 900 is being viewed, and the processor has determined that the battery will not have enough energy to complete the remaining pre-programmed options for the day and through the night, in addition to saving enough energy for one emergency operation.

The user may avoid seeing this alert too often, however, by viewing the “Battery Charge” page illustrated in FIG. 9d. The user is able to see a pictorial and numerical estimation of the remaining battery charge 926 for each automated window or window covering, which is not always the actual amount of charge remaining in the battery, but the predicted amount of energy that will be generated yet in the day, as the invention predicts. Additionally, the user may use the information about the predicted battery charge remaining before deciding whether or not they are going to use up the battery charge to open or close the window. As shown in the drawing, the batteries have different charges remaining. The two windows in the master bedroom have very different levels of charge left as depicted by icons 928 and 930, not due to different levels of use, but different levels of sunlight exposure. This is because, as discussed earlier, each individual solar panel that charges the battery has unique positioning in relation to the sun that makes its daily energy generation unique from other similarly placed solar power systems.

FIG. 9d depicts the potential battery charge as a percentage of a battery power. This is one embodiment of a page of the user interface. Another page may include telling the user the amount of battery charge remaining in each window or window covering in terms of number of uses remaining, as this may be more useful information. For example, instead of saying that the master bedroom window has a 36% charge 928, the user interface page for Battery Charge 900 could inform the user that the automated window can be open and closed four more times until the next day. This count may intentionally undercount by one, concealing from the user enough energy to open the window in the event of emergency.

Features of the user interface beyond programming and operating of windows or window coverings are designed to set up user accounts, monitor any connected devices within the cloud-based network, and add other users.

After using an embodiment such as the Rooms page depicted in FIG. 9a, and perhaps setting a weekly program for the windows and window coverings in the home, the user may wish to access the controls on multiple devices, or to share access with others living in the home. The user interface programming is adapted to allow the user to save the settings and unique programing by creating a profile, which may then be password protected and identified with a unique username. Then, it is possible to mirror all of the settings on additional user interfaces, such as a tablet and laptop in addition to smartphones, as the user interface is defined.

Another feature of the user interface is that it is adapted to act as a hub for other home devices connected via the cloud-based network. One example of how this could be achieved is a “setup accessories” button may be provided to set up accessories related to a window covering or a group of windows. Such accessories may include, for example, a temperature sensor connected to a window covering, a security sensor connected to an automated window, or the like. A “setup accessories” button may enable a user to configure expansion ports or devices connected to expansion ports of the window covering. For example, in certain embodiments, sensors such as temperature sensors, security sensors, or the like, may be connected to various expansions ports of a window covering to allow the window covering to provide additional features and functions. The button may present a screen or page that allows these expansion ports or devices to be configured.

In certain embodiments, the opening and closing of window coverings may be coordinated with the turning on or off of lights in a room or space. For example, if lights in a room are turned off, the window coverings may be opened to compensate for the reduced amount of light. This allows natural light to replace artificial light and creates opportunities for conserving energy. In certain embodiments, lights may be automatically turned off and window coverings may be automatically opened to replace artificial light with natural light when conditions allow. In such embodiments, information regarding whether the light switch being on or off would need to be transmitted via the cloud-based network to the user interface. Additionally, real-time information regarding weather conditions outside could be collected from the Internet and also be used to determine when it is appropriate to open the window coverings to replace the interior lights. As with all automatic programming options, the user could override this feature, or permanently disable it. Also, the amount of energy available to the window coverings would have to be taken into account by the processor.

The controller, or user interface, may also receive and process information from online sources or to communicate with a user as appropriate. This communication may be via a user's smart device running an app. The user interface is able to communicate more than controls to the home automated devices, however. The user interface may be able to alert the user automatically in response to a signal from at least one of the sensors and warn the user.

For optimal functioning of the invention, the processor within the user interface acquires data from various sources. Some of these sources are home devices powered by the solar power system, such as a front-door security camera 220, as seen in FIG. 2. Others include an emergency alert system for extreme weather. The remote data may be transmitted from a remote system located in a separate part of a room, building, or outside of a building. The remote system may include at least one of a weather station, security system, wireless remote sensor device, fire alarm system, HVAC system, building control system, manufacturing control system, monitoring system; control system, or combinations thereof, wherein the remote sensors convert sensor data to an electrical signal. The remote sensors may include at least one of: electromagnetic, electrochemical, electric current, electric potential, magnetic; radio, air flow, accelerometers, pressure, electro-acoustic, electro-optical, photoelectric; electrostatic, thermoelectric, radio-acoustic, environmental, moisture, humidity, fluid velocity, position, angle, displacement, or combinations thereof.

The processor may communicate with a cloud-based network and mirror the stored settings and calendar data with the cloud-based network by sending and receiving system data to and from the cloud-based network. The system data may include all data in the non-transitory memory.

The remote data may include weather data, and the remote data from the remote sensors and remote systems. This data may be relayed to the actuation device via the cloud-based network.

The processor within the user interface may determine a remote command based on at least one of the remote data, the stored settings, calendar data, and as directed by predefined user settings, or combinations thereof. The processor may transmit the remote command to the controller. The processor may further monitor usage data of the actuator and provide the usage data to a disparate device. A simple explanation of this is that, if the processor receives information via the cloud-based network that a severe thunderstorm warning is in effect, it may send an alert to the screen of the user interface, and close all automated windows that are open, without any input from the user.

The user interface may wirelessly communicate to the controller of the home automation device, and the user interface may also receive and process information from online sources.

Regarding the automated window, in the preferred embodiment there is a communication system within the fixed motor assembly. The one or more communication systems may receive instructions from the external controller, which is the user interface, generate signals instructing the first motor to rotate in a direction, receive signals from the first motor regarding a status of the first motor, and generate a signal informing the external controller, or user interface, of the status of the first motor.

The automated window mechanism may include a network device connecting the automated window mechanism to one or more additional automated window mechanisms forming a system of networked mechanisms. FIG. 8 illustrates one example of how the communication systems and processors within the motorized windows allow for a network and automated action of the connected windows, even in the absence of the central external controller, the user interface.

The user's smart device may be connected to each network device of the one or more automated window mechanisms, as the user interface may be adapted to run on a smart device as an app; and the cloud-based network may include Bluetooth, WIFI, mesh network or similar wireless protocol. The cloud-based network may be a wireless Bluetooth mesh connecting the one or more motorized windows and may enable the automated window mechanisms to be fully functional and able to operate all system functions based on stored settings and sensor data from the two or more sensors without input from the user or external data sources.

The stored settings may include factory presets, calendars, charts, user input data, sensor data and scheduled data. The two or more sensors may include at least one of a remote sensor and a local sensor. The local sensor may be in close proximity to the automated window mechanism, within two feet of it. The remote sensor may be located outside the building or at location more than two feet from the automated window mechanism.

FIG. 8 shows examples of these features. Window 804 has processor 816 which receives data from a local and remote sensor. The local sensor 802 detects carbon monoxide. The remote sensor 810 relays remote data about weather information and emergency alerts, as an example. And processor 816 has non-transitory memory to store data for the operation of the window.

The processor may receive a user input from the one or more user interfaces. The processor may determine the control command based on the sensor data, the stored settings, the remote data, and the user input; and store system data and user input data in the non-transitory memory. The processor may mirror the stored settings with the cloud-based network by sending and receiving data to and from the cloud-based network. The processor may also receive command signals from the cloud-based network; transmit the sensor data to the cloud-based network; and transmit system data to the cloud-based network.

What this means, in effect, is that while the processor within the user interface is capable of all of the auto-programming options, and allowing the user to create weekly custom schedules, it does not only work by sending out a signal when a window should be open or closed. Each automated window or window covering may have a processor embedded within its motor that has non-transitory memory. In this case, the processor on the automated window is adapted to store the programming information for the other networked windows, as well as has the ability to receive and respond to information from local and remote sensors, as well as any other home automation devices that are connected via the cloud-based network.

The cloud-based network may have a wired or wireless connection to each network device of the one or more motorized windows; and the wireless connection may include Bluetooth, WIFI, mesh network or similar wireless protocol. The one or more motorized windows may be connected via the wireless Bluetooth mesh; and the automated window system may be fully functional and able to operate all system functions based on the stored settings and sensor data without input from the user or the cloud-based network.

The user settings changed by a user on one user interface of the one or more user interfaces during a time period when another user interface is out of range of the cloud-based network may be stored in internal non-transitory memory of the one user interface for upload to the system once the user is within range of either the cloud-based network or the network device.

Primary control of the individual network device may be based on local control by the controller of the individual network device. Secondary control may be from the cloud-based network. Direct user control supersedes both the primary control and the secondary control.

The system may be controlled by or via the cloud-based network. The processor may create a passkey based on the one or more user inputs. The passkey may restrict levels of permission for a specific user to allow only control actions and only settings changes specified by a master user. The stored settings may further include factory presets, calendars, charts and scheduled data informing the processor.

Real-time data including weather data, and sensor data from the remote sensors and remote systems may be relayed via the cloud-based network to the system. The real-time data may modify and update the calendars, the charts and the scheduled data. The real-time data may also be used to control the system as directed by predefined user settings and the stored settings.

A Wi-Fi or Bluetooth enabled communication module may enable communication between the motorized window and external devices. The communication module may also, in certain embodiments, act as a repeater to repeat signals to other devices. This may allow the communication module (and associated window covering) to form part of a mesh network of interconnected devices. In some cases, a window covering may originate signals that are used to control other devices. FIG. 7 features one embodiment of this. Temperature sensor 730 connected to a window covering may measure temperature at or near a window. The measured temperature may be transmitted to a thermostat or other device to make adjustments to an HVAC system. Additionally, or alternatively, commands may be sent directly to an HVAC system to make adjustments thereto. Thus, in certain embodiments, the communication module may originate signals that are used to control devices external to the window covering.

A light sensor may sense light levels at or around a window covering. Various types of light sensors, including photovoltaic cells, cameras, photo diodes, proximity light sensor, or the like, may be used depending on the application. In certain embodiments, a light sensor may sense light external to a window. This may allow a window covering to open or close in response to lighting conditions outside a building. For example, a window covering may be configured to open at sunrise and close at sunset. Alternatively, or additionally, a window covering may be configured to open (either fully or partially) when conditions are overcast, thereby letting more light into a room or space, and close (either fully or partially) in response to detecting full sunlight, thereby letting less light into a room or space. In certain embodiments, a light sensor may be used to determine a total amount of light energy entering a room or space through a window. This information may be used to adjust a window blind or window covering or adjust HVAC system parameters.

The automated window device has a solar panel adapted to charge the batteries. The sensors, if any, may consist of at least one of carbon monoxide; carbon dioxide; smoke; fire; humidity; moisture; dust; pollen; environmental; motion; electromagnetic; electrochemical; electric current; electric potential; magnetic; radio; air flow; accelerometers; pressure; electro-acoustic; camera; electro-optical; photoelectric; electrostatic; thermoelectric; radio-acoustic; air quality; motion; attempted movement of the slidable segment; intrusion; sunlight and noise; and combinations thereof. The controller may receive signals from the two or more sensors and operate the first motor to move the slidable frame to an open or closed position as appropriate without input from a user.

A motorized window or group of motorized windows may be configured to open or close in response to changing detected motion, detected noise, detected security situations, detected safety situations, or the like. These conditions may be conditions inside a building, outside a building, or a combination thereof.

A light sensor may also be configured to sense light levels internal to a window, such as within a room or interior space. This may allow a window blind to be adjusted based on interior light levels. For example, a window blind may be opened in response to lower levels of interior light and closed in response to higher levels of interior light. In certain embodiments, various algorithms may be used to adjust window blinds in response to both exterior and interior light levels, as opposed to just one or the other. Thus, in certain embodiments light sensors may be provided to sense both exterior and interior light levels.

Real-time data including weather data, and sensor data from the remote sensors and remote systems may be relayed via a cloud-based network to the system. The real-time data may modify and update the calendars, the charts and the scheduled data. The real-time data may also be used to control the system as directed by predefined user settings and the stored settings.

Each automated window mechanism within the system may be fully autonomous and operational without any connection to other automated window mechanisms in the system.

Sensor data from all automated window mechanisms within the system of networked mechanisms may be reported to the controller of each automated window mechanism in the system, and to one processor adapted to analyze the data from all of the sensors.

The processor may receive sensor data from the one or more sensors; receive remote data from a cloud-based network; determine a control command based on the sensor data, the stored settings, and the remote data. The processor may transmit the control command to the controller.

Each network device and each mobile device within the mesh network may broadcast global data to all network devices within the network. The global data may include data applicable to all network or mobile devices within the mesh network, and may be organized in one or more data groups, each data group including data specific to each individual network or mobile device. Monitoring and control of each individual network or mobile device may only respond to only the specific data associated with that individual network or mobile device.

There are uses for sensors in automated home devices beyond motorized windows. Recall that the solar power system may also be used to power alarm systems, outdoor security cameras, and lights. Various security sensors may be configured to work together in certain embodiments. For example, a motion sensor may, upon sensing motion, trigger operation of a camera, microphone, or other data gathering sensor. In FIG. 2, house 202 has a motion sensor 218 that is powered by the solar power system as described in the invention. It is scheduled to operate from the hours of midnight to six am. Additionally, it is connected via the cloud-based network to the LED flood lights 214 located in the front yard as well as the camera 220. Both the LED lights and camera are powered by the solar power system as well. In this embodiment of the invention, when the motion sensor is activated, the flood lights 214 turn on and the camera 220 turns to face the source of motion. This chain of events could warn a potential intruder that he or she has been detected. This may provide a deterrent effect. The camera, which is connected to the cloud-based network, may automatically send its feed to the user interface, so that the user can assess the situation quickly and conveniently. In other embodiments, a motion sensor may trigger operation of a motorized window. For example, if a motion sensor detects that an intruder is approaching a window, the motion sensor may trigger closing of the motorized window to obstruct the view through the window. Thus, security sensors may, in certain embodiments, trigger automatic operation of a motorized window or a group of motorized windows.

In certain embodiments, the user device interfaces with one or more other home electronic automated devices, including cameras and outdoor lights intended for security purposes. Linked by a cloud-based network, various sensors inform the controller regarding conditions that may influence the operation of the device. For example, an entry sensor that senses an intrusion notifies the user interface that in turn alerts a security camera, and possibly, additional security features within the home. The entry sensor may include a window or door switch, or a glass breaking sensor. The controller may further notify the home owner via the cloud-based network that there has been an intrusion. Thus, when a sensor embedded within the window transmits that the window has been broken and someone may have unlawfully entered the user's home, the user may get a flashing alert to warn them on their mobile device, as well as have their connected security camera and outdoor flood lights turn on, if the user has these two items, security camera and outdoor flood lights, and they are connected to their cloud-based network of home automated devices.

An automated motorized window in accordance with the invention may also be configured to interface with external sensors. Although various sensors (as previously discussed) may be located in the motorized window or in close proximity to the motorized window, other sensors may be located external to the motorized window and, in some cases, be far removed from the motorized window. For example, a smoke detector sensor located in one part of a building may be used to trigger operation of motorized windows in other parts of the building. In other cases, readings from multiple sensors located throughout a building may be used to influence operation of a motorized window or a group of motorized windows. In certain cases, data may be gathered from external sensors and wirelessly communicated to a motorized window or group of motorized windows.

One of the features of the preferred embodiment is that the processor is adapted to save enough battery charge for the operation of the motorized window to be able to work in an emergency situation. Certain emergency situations may be determined by the user, such as when an intruder is in the home and they desire an additional exit route. Another emergency scenario, though, is sensed and acted on automatically via certain sensors and controllers within the automated window. Users may choose what sensors they wish to have in their home. The processor within the solar power system always saves enough energy to open and close the motorized window one time, in case of such events. The minimum amount of energy required is to provide power to the actuator; one or more sensors, if present, each configured to generate signals related to a different environmental condition; and a controller adapted to receive the signals from the one or more sensors and operate the actuator to move the slidable window to an open or closed position as appropriate.

Outfitting motorized windows with such sensors may provide a large number of sensors at prime locations throughout a home or business, while at the same time eliminating or reducing the need to equip a home or business with separate independent sensors. In certain embodiments, alerts or notifications may be sent to a user or first responder when smoke, carbon monoxide, or other critical substances or gases have been detected.

The sensors listed above are only an example of the sensors that could be utilized by the user interface and cloud-based network of home automation devices to improve home security and safety. And the following is a non-limiting list of output devices, or devices that can be connected to the cloud-based network to provide a response to certain threats picked up by the sensors, other than the windows. Output devices may include, for example, LEDs, alarms, speakers, or devices to provide feedback to a user. Such output devices may be triggered, for example; when motion has been detected by an automated window or window covering (in embodiments where a motion sensor is incorporated into the window blind); when connectivity is enabled, disabled, or lost between the automated window or window covering and other devices; when the window or window covering has experienced an error or other fault condition; when the sensor has detected smoke, carbon monoxide, or other gases (in the event a smoke or gas detector is incorporated into the window or window covering); when a security event is detected, or the like. Such output devices may, in certain embodiments, be incorporated into a headrail of the window blind, a solar panel attached to the window, or the like.

Although particular reference has been made herein to motorized windows, automated window coverings, and actuators, various features and functions of the disclosed embodiments of the invention may equally apply to other associated systems such as automated shutters, curtains, shades, etc. The disclosed features and functions may also be applicable to other related systems. For example, different features and functions disclosed herein may be used to automatically raise and lower the slats of motorized windows, along with adjusting the tilt of the slats. Thus, where applicable, the disclosed features and functions may be used with other systems.

Additionally, repeated mention has been made of “home automation devices” and connected security systems for the home. Neither the invention nor its embodiments is limited, however, to usage in a residential setting. All of the described features of the invention and its embodiments are equally applicable in commercial and industrial settings.

The apparatus and methods disclosed herein may be embodied in other specific forms without departing from their spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A solar power system comprising:
a solar panel adapted to generate energy;
a battery adapted to be charged by the current generated by the solar panel;
a sensor adapted to generate signals indicating amount of energy generated by the solar panel;
a controller adapted to regulate the charging of the battery;
a processor adapted to monitor the charge of the battery and to predict the amount of energy that will be available from the battery;
wherein the processor receives signals from the sensor over predetermined periods of time on separate days in different seasons, to thereby generate individualized sample data on the amount of energy generated by the solar panel in different seasons;
wherein the processor comprises non-transitory memory for storing the sample data; and
wherein the processor uses the stored sample data in predicting the amount of energy available from the battery on a particular day.

2. The invention of claim 1, further comprising a user interface, whereby a user can receive information about the predicted amount of energy available from the battery.

3. The invention of claim 2, wherein the user interface is provided by a smart device running an app.

4. The invention of claim 1, wherein the processor also receives online weather data and combines that online weather data with the stored sample data in predicting the amount of energy available from the battery on a particular day.

5. The invention of claim 1, wherein the solar power system provides energy to a home automation device.

6. The invention of claim 5, wherein the home automation device is selected from a motorized window, a motorized window covering, a security system, a light, a pool filter and other pool maintenance devices.

7. The invention of claim 5, wherein the home automation device is programmable by a user and wherein the programming options available on a particular day take into account the predicted amount of energy.

8. The invention of claim 5, wherein the processor is adapted to reserve a predetermined percentage of the predicted amount of energy for emergency operation of the home automation device.

9. The invention of claim 5, wherein the processor is adapted to reserve a predetermined percentage of the predicted amount of energy for operation of the home automation device during night hours.

10. The invention of claim 5, further comprising:
a sensor, configured to generate signals related to an environmental condition;
wherein a processor is adapted to receive the signals from the sensor and operate the automated home device in a response appropriate to the environmental condition.

11. A solar-powered automated window system, comprising:
one or more automated window components selected from a sliding window, a hinged window and a window covering, each automated window component comprising an actuator and a first controller that controls the actuator;
a solar panel adapted to generate energy for the one or more automated window components;
a battery adapted to be charged by the current generated by the solar panel;
a sensor adapted to generate signals indicating amount of current and voltage generated by the solar panel;
a second controller adapted to regulate the charging of the battery;
a processor adapted to monitor the charge of the battery and to predict the amount of energy that will be available from the battery; and
a user interface for providing instructions to the first controller;
wherein the processor receives signals from the current and voltage sensor over predetermined periods of time on separate days in different seasons, to thereby generate individualized sample data on the amount of energy generated by the solar panel in different seasons;
wherein the processor comprises non-transitory memory for storing the sample data;
wherein the processor uses the stored sample data in predicting the amount of energy available from the battery on a particular day; and
wherein the user interface is adapted to receive information about the predicted amount of energy available for the one or more automated window components.

12. The invention of claim 11, wherein the processor also receives online weather data and combines that online weather data with the stored sample data in predicting the amount of energy available from the battery on a particular day.

13. The invention of claim 11 wherein the one or more window components are programmable by a user and wherein the programming options available on a particular day take into account the predicted amount of energy.

14. The invention of claim 13 adapted to block a programming option when the predicted energy available is insufficient to complete the programming option.

15. The invention of claim 11, wherein the processor is adapted to reserve a predetermined percentage of the predicted amount of energy for emergency operation of the home automation device.

16. The invention of claim 11, wherein the processor is adapted to reserve a predetermined percentage of the predicted amount of energy for operation of the home automation device during night hours.

17. The invention of claim 11, wherein the user interface is adapted to alert a user when the predicted energy available is approaching an amount insufficient to power the automated window system.

18. The invention of claim 11, wherein the user interface is adapted to receive and send information over a cloud-based network.

19. The invention of claim 18, wherein the user interface is adapted to integrate with a smart device.

20. The invention of claim 11, further comprising:
a sensor, configured to generate a signal related to an environmental condition; and
wherein a processor is adapted to receive the signal from the sensor and operate the actuator to move the automated window component to an open or closed position as appropriate.
